(19) United States
(12) Patent Application Publication
(10) Pub. No.: US 2011/0073004 A1
(43) Pub. Date: Mar. 31, 2011

(54) Water-Based Ink for Ink-Jet Recording, Ink Cartridge, Ink-Jet Recording Apparatus, Ink-Jet Recording Method, Method for Producing Water-Based Ink for Ink-Jet Recording, and Method for Preventing Corrosion of Metal Members of Ink-Jet Recording Apparatus

(75) Inventors: Ryuji KATO, Kiyosu-shi (JP); Junichiro Sugimoto, Nagoya-shi (JP)

(73) Assignee: BROTHER KOGYO KABUSHIKI KAISHA, Nagoya-shi (JP)

(21) Appl. No.: 12/748,427

(22) Filed: Mar. 28, 2010

(30) Foreign Application Priority Data
Sep. 30, 2009 (JP) 2009-226711

(51) Int. Cl. C09D 5/08; C09D 11/02; B41J 2/135

(52) U.S. Cl. 106/14.12; 106/31.85; 347/100; 347/44

(57) ABSTRACT

A water-based ink for ink-jet recording includes a self-dispersible C.I. Pigment Red 122 of which surface is modified by sulfonate group; water; and a water-soluble organic solvent, wherein the water-based ink contains phosphate ion with not more than 20 ppm.

### CROSS REFERENCE TO RELATED APPLICATION

The present application claims priority from Japanese Patent Application No. 2009-226711 filed on Sep. 30, 2009 the disclosure of which is incorporated herein by reference in its entirety.

### BACKGROUND OF THE INVENTION

1. Field of the Invention

The present invention relates to a water-based ink for ink-jet recording, an ink cartridge, an ink-jet recording apparatus, an ink-jet recording method, a method for producing a water-based ink for ink-jet recording, and a method for preventing corrosion of a metal member (metal part or component) of the ink-jet recording apparatus.

2. Description of the Related Art

In the ink-jet recording, a water-based ink using a self-dispersible pigment is used in some cases. Since the self-dispersible pigment does not require any polymeric pigment dispersant, the self-dispersible pigment is capable of preventing the viscosity of the water-based ink from increasing, and has excellent controlling performance. While variety of kinds of pigment is exemplified as the pigment usable in the self-dispersible pigment, C.I. Pigment Red 122 is used in many cases as a magenta pigment in view of color vividness or brightness and storage stability. Further, the self-dispersible pigment can be obtained by performing a surface treatment for a pigment such that at least one hydrophilic group such as carbonyl group, carboxyl group, hydroxyl group or sulfonate group (sulfone group), or the salt thereof is bonded to the pigment surface. A self-dispersible pigment, which is treated in particular with the sulfonate group among the surface-treating groups, has a satisfactory dispersion stability of the pigment for a long period of time, and thus such self-dispersible pigment is widely used. On the other hand, in an ink-jet head of the ink-jet recording apparatus, a metal member such as a nickel-containing metal in, for example, an ink channel in the ink-jet head. For this reason, there is a problem of corrosion (rust) in the ink-jet head caused by the water-based ink. To solve the problem of corrosion, there is proposed a method for adjusting the pH of the water-based ink from neutral to alkaline.

In the above-described method for adjusting the pH, however, the pH of the water-based ink becomes acidic over time, resulting in causing the corrosion in the metal member of the ink jet head. In particular, C.I. Pigment Red 122 surface-treated by the sulfonate group tends to corrode the metal member.

The present teaching has been made in order to solve the problems as described above, an object of which is to provide a water-based ink containing a self-dispersible pigment and capable of preventing the corrosion of a metal member in, for example, in the ink-jet head, etc., which contacts with the ink.

### SUMMARY OF THE INVENTION

According to a first aspect of the present teaching, there is provided a water-based ink for ink-jet recording including: a self-dispersible C.I. Pigment Red 122 of which surface is modified by sulfonate group; water; and a water-soluble organic solvent, wherein the water-based ink contains phosphate ion with not more than 20 ppm.

According to a second aspect of the present teaching, there is provided an ink cartridge including the water-based ink for ink-jet recording of the first aspect.

According to a third aspect of the present teaching, there is provided an ink-jet recording apparatus including: an ink accommodating section accommodating the ink cartridge of the second aspect; an ink-jet head which ejects the water-based ink accommodated in the ink accommodating section; and a metal member which contacts with the water-based ink.

According to a fourth aspect of the present teaching, there is provided an ink-jet recording method including: preparing the water-based ink for ink-jet recording of the first aspect; and performing an ink-jet recording by ejecting the water-based ink onto an object.

According to a fifth aspect of the present teaching, there is provided a method for producing a water-based ink for ink-jet recording, the method including: performing ultrafiltration for a self-dispersible C.I. Pigment Red 122 dispersion of which surface is modified by the sulfonate group; and mixing the self-dispersible C.I. Pigment Red 122 dispersion for which the ultrafiltration is performed, water, and a water-soluble organic solvent; wherein the water-based ink contains phosphate ion with not more than 20 ppm.

According to a sixth aspect of the present teaching, there is provided a method for preventing corrosion of a metal member, of an ink-jet recording apparatus, which contacts with a water-based ink for ink-jet recording, the method including: preparing, as the water-based ink for ink-jet recording, a water-based ink which includes a self-dispersible C.I. Pigment Red 122 of which surface is modified by sulfonate group; water; and a water-soluble organic solvent, and contacting the water-based ink with the metal member, wherein the water-based ink contains phosphate ion with not more than 20 ppm.

### BRIEF DESCRIPTION OF THE DRAWINGS

FIG. 1 is a schematic perspective view showing an example of the construction of an ink-jet recording apparatus in a fourth embodiment.

FIG. 2 is a flow chart for explaining a method for producing a water-based ink for ink-jet recording according to examples.

### DESCRIPTION OF THE PREFERRED EMBODIMENTS

An explanation will be given about a water-based ink for ink-jet recording (hereinafter referred to simply as “water-based ink” or “ink”) as a first embodiment. The water-based ink of the first embodiment contains a colorant, water, and a water-soluble organic solvent. As described above, the colorant includes C.I. Pigment Red 122 of which surface is modified by the sulfonate group (hereinafter referred to as “self-dispersible magenta pigment”). As the self-dispersible magenta pigment, for example, a commercially available product may be used. The commercially available product is exemplified by “CAB-O-JET (trade name) 260M” produced by Cabot Specialty Chemicals, etc. Since the water-based ink of the first embodiment uses the self-dispersible pigment as described above, there is not any problem of the increase in viscosity which would be otherwise caused by the polymeric pigment dispersant; and the water-based ink of the first embodiment has excellent controlling performance or usability performance. In the description of the present teaching, the term “controlling performance or usability performance” of the ink means the jetting stability during the ink-jet recording, the color vividness or brightness in a printed matter, etc.

The solid content blending amount (pigment ratio; pigment solid content) with respect to the entire water-based ink is not particularly limited, and may be appropriately determined based on, for example, desired optical density or color (hue, tint), etc. The pigment ratio is, for example, 0.1% by weight to 20% by weight, is preferably 0.1% by weight to 10% by weight, and is more preferably 2% by weight to 8% by weight.

The colorant may include a pigment, a dye, etc. which is/are different from the self-dispersible magenta pigment, in addition to the self-dispersible magenta pigment.

The water is preferably ion-exchanged water or pure water (purified water). The blending amount of the water with respect to the entire water-based ink is, for example, 10% by weight to 90% by weight, and is preferably 40% by weight to 80% by weight. The water ratio may be balance of other components.

The water-soluble organic solvent includes, for example, a humectant which prevents the water-based ink from drying at an end of the nozzle in the ink-jet head and/or a penetrant which adjusts the drying speed of the water-based ink on a recording medium.

The humectant is not particularly limited, and includes, for example, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyvalent alcohols such as polyalkylene glycols, alkylene glycols, and glycerol; 2-pyrrolidone; N-methyl-2-pyrrolidone; and 1,3-dimethyl-2-imidazolidinone. The polyalkylene glycol is not limited, and includes, for example, polyethylene glycol and polypropylene glycol. The alkylene glycol is not limited, and includes, for example, ethylene glycol, propylene glycol, butylenes glycol, diethylene glycol, triethylene glycol, dipropylene glycol, tripropylene glycol, thiodiglycol, and hexylene glycol. It is allowable that only one type of the humectant as described above is used, or two or more types of the humectants are used. Among the above-described humectants, it is preferable to use polyvalent alcohols such as alkylene glycol and glycerol.

The blending amount of the humectant with respect to the entire water-based ink is, for example, 0% by weight to 95% by weight, is preferably 5% by weight to 80% by weight, and is more preferably 5% by weight to 50% by weight.

The penetrant is not limited, and includes, for example, glycol ether. The glycol ether is not limited, and includes, for example, ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. It is allowable that only one type of the penetrant as described above is used, or two or more types of the penetrants are used.

The blending amount of the penetrant with respect to the entire water-based ink (penetrant ratio) is, for example, 0% by weight to 20% by weight. By making the penetrant ratio within the above-described range, it is possible to make the permeability of the water-based ink into the recording medium to be more suitable. The penetrant ratio is preferably 0.1% by weight to 15% by weight, and is more preferably 0.5% by weight to 10% by weight.

The concentration of the phosphate ion (phosphate ion concentration) in the water-based ink is not more than 20 ppm by weight, as described above. By making the phosphate ion concentration be not more than 20 ppm, it is possible to obtain the water-based ink for ink-jet recording which is capable of preventing the corrosion of a metal member, for example, in or of the ink-jet head, etc. The phosphate ion concentration in the water-based ink is preferably not more than 0.4 ppm by weight. It is preferable that the phosphate ion concentration is as low as possible, and the lower limit is not particularly limited; for example, the phosphate ion concentration is 0 (measurable limit).

The water-based ink which uses the self-dispersible magenta pigment, namely self-dispersible C.I. Pigment Red 122 of which surface is modified by the sulfonate group, tends to corrode the metal member. In the corroded metal member, since a corroded portion of the metal (metal member) is colored, it is assumed that the corrosion is caused by the self-dispersible magenta pigment and that the sulfonate group on the surface of the pigment is involved. The inventors found out, through a series of research and study, that the phosphate ion in the water-based ink is a substance which promote the corrosion of the metal by the self-dispersible magenta pigment, and that the corrosion of the metal member, which contacts with the ink, of the ink-jet head, etc. can be prevented by making the phosphate ion concentration in the water-based ink be not more than 20 ppm, preferably not more than 0.4 ppm. Although the mechanism for the above-described corrosion-preventing effect is not clear, it is assumed that the phosphate ion has any interaction with the self-dispersible magenta pigment and the surface of the metal and promotes the adhesion of the self-dispersible magenta pigment to the surface of the metal. Accordingly, even with respect to the water-based ink using the self-dispersible magenta pigment having the sulfonate acid, it is possible to obtain a water-based ink which hardly corrode the metal by making the phosphate ion concentration be not more than 20 ppm. Note that this effect is observed particularly in the water-based ink using the self-dispersible magenta pigment. From this also, it is assumed that the phosphate ion and the self-dispersible magenta pigment have any interaction therebetween and affect the corrosion of the metal.

Further, the water-based ink of the first embodiment can also prevent clogging of the ink channel which would be otherwise caused by the adhesion of the pigment due to the corrosion. Further, since the water-based ink of the first embodiment uses the self-dispersible pigment, the water-based ink does not cause any problem of increased viscosity which would be otherwise cause due to the polymeric pigment dispersant, and the water-based ink has excellent controlling performance.

The water-based ink may further contain a conventionally known additive, if necessary. The additive includes, for example, surfactants, pH-adjusting agents, viscosity-adjusting agents, surface tension-adjusting agents, and fungicides. The viscosity-adjusting agents include, for example, polyvinyl alcohol, cellulose, water-soluble resin, etc.

The water-based ink of the first embodiment can be used, for example, as a water-based magenta ink. However, the water-based ink of the first embodiment is not limited to this. The water-based ink of the first embodiment can be used as a water-based ink having a color which is different from magenta, by using a colorant other than the self-dispersible magenta pigment.

An explanation will be given about a method for producing the water-based ink of the first embodiment, as a second embodiment. The water-based ink of the first embodiment can be prepared, for example, such that the colorant, the water, and the water-soluble organic solvent, and optionally other additive component(s) as necessary are mixed uniformly or homogeneously by any conventionally known method, and undissolved matters are removed by a filter or the like, except that in the second embodiment the phosphate ion concentration is made to be not more than 20 ppm, preferably not more than 0.4 ppm.

The phosphate ion is a substance which is a possibility of being contained (present), as an impurity, in various chemicals, pigments, water, etc. When the water-based ink is prepared by using a material having a low purity, unpurified material, etc., then the water-based ink contains the phosphate ion in a concentration of not less than 20 ppm. Accordingly, in order to make the phosphate ion concentration in the water-based ink be not more than 20 ppm, preferably not more than 0.4 ppm, a material having a high purity or a purified material is used to prepare the water-based ink. It is allowable to perform, as necessary, removal of the phosphate ion in the production process of the water-based ink. It is also allowable to perform the removal of the phosphate ion with respect to a material (component) for the water-based ink. Alternatively, it is allowable that while preparing the water-based ink, namely in a state that the components or materials are mixed, the phosphate ion is removed from the mixture. As a method for removing the phosphate ion, it is possible to use, for example, a publicly known method such as the ultrafiltration method, ion-exchange method and phosphate ion absorption method using boehmite, etc. In particular, a method for producing the water-based ink including a step of removing the phosphate ion from the self-dispersible magenta pigment dispersion by the ultrafiltration method is preferable since it is possible to easily obtain a water-based ink having the phosphate ion concentration of not more than 0.4 ppm.

Next, an explanation will be given about an ink cartridge as a third embodiment. In the ink cartridge of the third embodiment, the ink cartridge is an ink cartridge containing a water-based ink for ink-jet recording; and that the water-based ink for ink-jet recording is the water-based ink for ink-jet recording of the first embodiment. It is possible to use, as a body of the ink cartridge, a conventionally known body of ink cartridge.

Next, an ink-jet recording apparatus will be explained as a fourth embodiment. The ink-jet recording apparatus of the fourth embodiment includes an ink accommodating section and an ink discharge mechanism (ink-jet head), wherein an ink accommodated in the ink accommodating section is discharged by the ink discharge mechanism. Further, in the ink-jet recording apparatus of the fourth embodiment, the ink-jet recording apparatus includes a metal member which contacts with the ink and that the ink cartridge of the third embodiment is accommodated in the ink accommodating section. The metal member which contacts with the ink includes, for example, an ink channel in the ink discharge mechanism, etc. The metal member(s) includes, for example, nickel, iron, and chrome, etc. With respect to the remaining portions or parts of the construction of the ink-jet recording apparatus of the fourth embodiment may be substantially same as, for example, a conventionally known ink-jet recording apparatus.

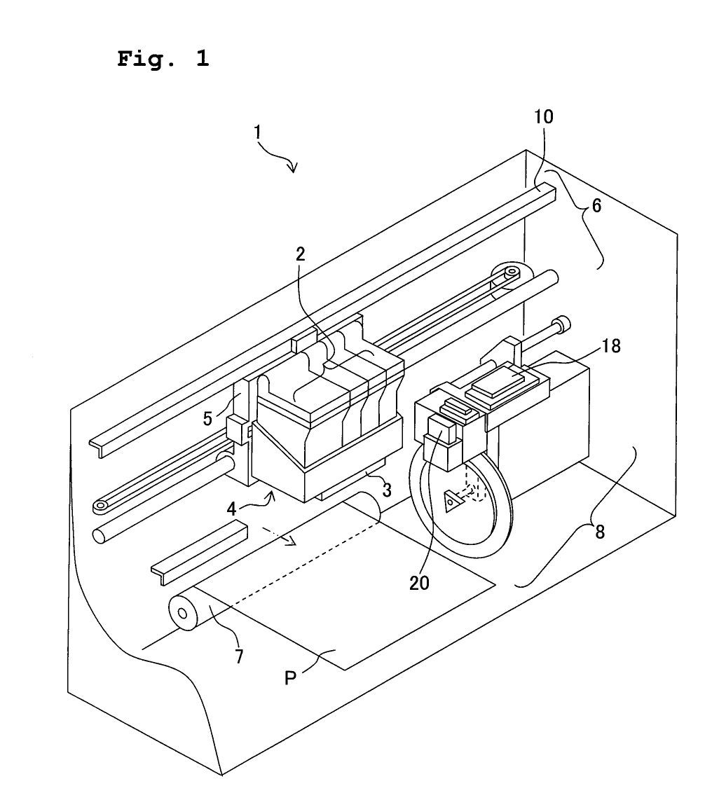

As shown in FIG. 1, an ink-jet recording apparatus 1 includes four ink cartridges 2, an ink discharge mechanism (ink jet head) 3, a head unit 4, a carriage 5, a driving unit 6, a platen roller 7 and a purge device 8 as main constitutive components or parts.

The four ink cartridges 2 contain four colors of water-based inks respectively, the four colors being yellow, magenta, cyan and black. For example, an ink cartridge 2, among the four ink cartridges 2, which contains the water-based magenta ink, is the ink cartridge of the third embodiment. The ink jet head 3 performs recording on a recording medium (recording-objective medium) P such as a recording paper (recording paper sheet). The head unit 4 is provided with the ink jet head 3. The four ink cartridges 2 and the head unit 4 are provided or arranged on the carriage 5. The driving unit 6 reciprocates the carriage 5 in a linear direction. As the driving unit 6, it is possible to use, for example, a conventionally known driving unit (see, for example, Japanese Patent Application laid-open No. 2008-246821). The platen roller 7 extends in the reciprocating direction of the carriage 5 and is arranged to face or be opposite to the ink jet head 3. The recording includes printing a letter, printing an image, etc.

The recording medium P is supplied or fed from a paper feeding cassette (not shown) arranged at a side of or at a position below the ink-jet recording apparatus 1. The recording medium P is introduced or guided between the ink jet head 3 and the platen roller 7. Then, a predetermined recording is performed on the recording medium P with the ink discharged or jetted from the ink jet head 3. Afterwards, the recording medium P is discharged from the ink-jet recording apparatus 1. In FIG. 1, the paper feeding mechanism and discharging mechanism for the recording medium P are omitted.

The purge device 8 sucks unsatisfactory or degraded ink into and with which air bubbles, etc. accumulated in the ink jet head 3 enters and mixed. As the purge device 8, it is possible to use, for example, a conventionally known purge device (for example, see Japanese Patent Application laid-open No. 2008-246821).

A wiper member 20 is provided on the purge device 8, at a position on the side of the platen roller 7 such that the wiper member 20 is adjacent to the purge device 8. The wiper member 20 is formed to have a spatula form, and wipes a nozzle-formation surface of the ink jet head 3 accompanying with the movement (reciprocating movement) of the carriage 5. In FIG. 1, a cap 18 of the purge unit 8 is provided to cover a plurality of nozzles of the ink jet head 3 which is returned to a reset position upon completion of the printing, so as to prevent the ink from drying.

In the ink-jet recording apparatus, the four ink cartridges may be provided on a plurality of carriages. Alternatively, the ink cartridges may be arranged and fixed inside the ink-jet recording apparatus, rather than being provided on the carriage. In such an aspect, for example, the ink cartridges and the head unit which is provided on the carriage are connected with a tube, etc., and the inks are supplied from the ink cartridges to the head unit.

The ink-jet recording apparatus of the fourth embodiment may be a serial-type ink-jet recording apparatus as shown in FIG. 1, or may be a line-type ink-jet recording apparatus.

Next, an explanation will be given about an ink-jet recording method as a fifth embodiment. The ink-jet recording method of the fifth embodiment is an ink-jet recording method for performing recording by discharging an ink from an ink discharging mechanism including a metal member, and the water-based ink for ink-jet recording of the first embodiment is used as the ink.

Next, as a sixth embodiment, an explanation will be given about a method for preventing corrosion of a metal member of ink-jet recording apparatus. The method for preventing corrosion of a metal member of the ink-jet recording apparatus of the first embodiment is a method for preventing corrosion of a metal member of the ink-jet recording apparatus caused by a water-based ink including the self-dispersible magenta pigment, and the method is that the phosphate ion concentration in the water-based ink is made to be not more than 20 ppm, preferably not more than 0.4 ppm. In the method for preventing corrosion of the metal member of the ink-jet recording apparatus of the sixth embodiment, it is preferable that the metal member is a metal member of the ink-jet head.

In the ink-jet recording method of the fifth embodiment and the method for preventing corrosion of metal member of the ink-jet recording apparatus of the sixth embodiment, it is possible to make the kind, blending amount, aspect of the respective components, such as the colorant, etc. be same as those of the water-based ink for ink-jet recording of the first embodiment.

### EXAMPLES

Next, examples of the present teaching will be explained together with comparative examples and reference examples. Note that the present teaching is not limited to the examples, the comparative examples and the reference examples as described below.

### Examples 1 and 2

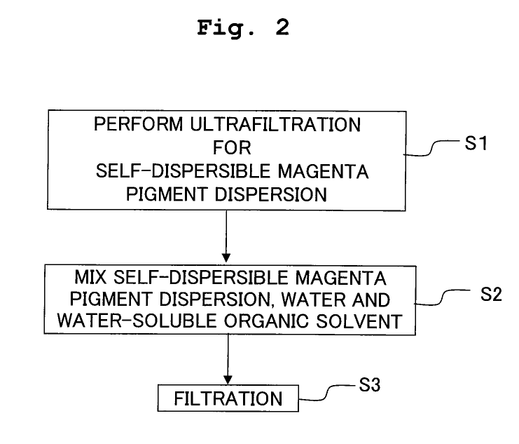

With reference to FIG. 2, an explanation will be given about the method for producing the water-based ink for ink-jet recording of Examples 1 and 2.

### Removal of Phosphate Ion

First, phosphate ion was removed from a self-dispersible magenta pigment dispersion (CAB-O-JET (trade name) 260M: pigment dispersion with pigment concentration of 10% by weight) with the ultrafiltration method as described (1) to (3) below (Step S1).

(1) 10 g of pure water was placed in a ultrafiltration set (MACROSEP 10K OMEGA, produced by Pall Corporation; elimination limit molecule quantity: 1,000), the ultrafiltration set was placed in a centrifugal separator (HIMAC CT15D produced by Hitachi-Koki, Ltd.); and then the centrifugal separator was driven for 10 minutes at 10,000 rpm to thereby clean a filter of the ultrafiltration kit.

(2) After the cleaning, the pure water was discarded and 10 g of the self-dispersible magenta pigment was placed in the ultrafiltration set; the ultrafiltration set was placed in the centrifugal separator; and then the centrifugal separator was driven.

(3) The self-dispersible magenta pigment remaining on the filter of the ultrafiltration set was recovered and was dispersed again in pure water.

The operations of (1)-(3) were repeated two times. Thus, the self-dispersible magenta pigment from which the phosphate ion was removed was obtained. The remaining amount of the phosphate ion remaining in the self-dispersible magenta pigment was adjusted by the rotational frequency (number of revolutions) and the rotational time of the centrifugal separator. For example, in Example 1, the centrifugal separator was driven for 2 hours at 7,000 rpm.

### Preparation of Water-Based Ink

The above-described self-dispersible magenta pigment from which the phosphate ion was removed was used as the pigment, and water-based inks of Examples 1 and 2 were prepared based on water-based ink composition component (TABLE 1) as follows. First, components except for the self-dispersible magenta pigment dispersion, which were included in the water-based ink composition components (TABLE 1), were mixed uniformly or homogeneously to obtain ink solvents. Subsequently, the ink solvents were added little by little to the self-dispersible magenta pigment from which the phosphate ion was removed, followed by being mixed uniformly (step S2). After that, obtained mixtures were filtrated through a cellulose acetate membrane filter (pore size 3.00 μm) produced by Toyo Roshi Kaisha, Ltd., and thus water-based inks for ink-jet recording of Examples 1 and 2 were obtained (step S3). The phosphate ion concentration in each of the water-based inks of Examples 1-2 was measured by means of anion chromatography under the following condition.

### Measuring Condition for Phosphate Ion Concentration:

Measuring device: ICS-2000 (model name) produced by Dionex Corporation

Column. AS18 (model name), 4 mm, produced by Dionex Corporation

Guard column. AG18 (model name), 4 mm, produced by Dionex Corporation

Eluent: 5 mmol/L aqueous solution of potassium hydroxide

Flow rate: 1 mL/min

Column temperature: 30 degrees Celsius

Injection rate: 25 μL

Detection: Electric conductivity (Suppressor method)

### Examples 3 and 4 and Comparative Examples 1-5

The self-dispersible magenta pigment dispersion before the phosphate ion was removed therefrom in Examples 1 and 2 was used as the pigment, and water-based inks of Examples 3 and 4 and Comparative Examples 1-5 were prepared based on the water-based ink composition component (TABLE 1). Note that in Example 4 and Comparative Examples 1 to 5, the phosphate ion concentration was adjusted by adding sodium hydrogenphosphate. The phosphate ion concentration in each of the inks of Examples 3 and 4 and Comparative Examples 1-5 was measured in a manner same as that in Examples 1 and 2.

### Reference Examples 1-4

Magenta pigment (C.I. Pigment Red 122) 10 parts by weight, “DISPERBYK (trade name) 190” 6 parts by weight, glycerol 14 parts by weight, and water 70 parts by weight were mixed, then dispersion treatment was performed in a wet sand mill using zirconia beads with a diameter of 0.3 mm as a medium to obtain a magenta pigment dispersion. Then, water 19 parts by weight (24 parts by weight in Reference Example 4), glycerol 23 parts by weight (18 parts by weight in Reference Example 4), dipropylene glycol 5 parts by weight, dipropylene glycol n-propyl ether 2 parts by weight, and “SUNNOL (trade name) NL-1430” 1 part by weight were mixed to prepare an ink solvent 50 parts by weight. The prepared ink solvent 50 parts by weight was then gradually added to the magenta pigment dispersion 50 parts by weight under stirring and the components were mixed for 30 minutes. The mixture thus obtained was then filtrated through a cellulose acetate membrane filter (pore size 3.00 μm) manufactured by Toyo Roshi Kaisha Ltd.; and thus water-based inks for ink-jet recording of Reference Examples 1 to 4 were obtained. Note that in Reference Examples 2 to 4, the phosphate ion concentration was adjusted by adding sodium hydrogenphosphate. The phosphate ion concentration in each of the water-based inks of Reference Examples 1 to 4 was measured in a same manner as that in Examples 1 to 4 and Comparative Examples 1 to 5.

### Reference Examples 5-7

Self-dispersible cyan pigment dispersion (CAB-O-JET (trade name) 250C, pigment dispersion with pigment concentration of 10% by weight) was used as the pigment, and water-based inks of Reference Examples 5-7 were prepared based on the water-based ink composition component (TABLE 1) and with a method same as those in Examples 1-4 and Comparative Examples 1-5. Note that in Reference Examples 6 and 7, the phosphate ion concentration was adjusted by adding sodium hydrogenphosphate. The phosphate ion concentration in each of the inks of Reference Examples 5-7 was measured in a manner same as those in Examples 1-4 and Comparative Examples 1-5.

With respect to the water-based inks of Examples 1-4, Comparative Examples 1-5 and Reference Examples 1-7, a plate-shaped test piece (nickel plate; surface area: 600 mm²) was immersed in each of the water inks of Examples 1-4, Comparative Examples 1-5 and Reference Examples 1-7 under the following conditions (a) to (c); and nickel elution amount from the test piece to each of the water-based inks was measured by using an ICP emission spectrophotometer CIROS-120EOP (model name) produced by Rigaku Corporation. Further, after the immersion period of time was elapsed, the test piece was taken out of each of the water-based inks, and the test piece was observed visually and microscopically. The evaluation was made based on the results of visual and microscopic observations, in accordance with the following evaluation criterion.

### Conditions for Test-Piece Immersion:

(a) Amount of each of the water-based inks of Examples 1-4, Comparative Examples 1-5 and Reference Examples 1-7: 10 g

(b) Temperature of the water-based ink: 60 degrees Celsius

(c) Immersion period of time: 5 days

### Immersion Evaluation Criterion:

G: No color change and no rust occurred in the nickel

NG: Color change and rust occurred in the nickel

The compositions and the measurement and evaluation results of the inks of Examples, Comparative Examples and Reference Examples are shown in TABLE 1.

TABLE 1

| | | EX. 1 | EX. 2 | EX. 3 | EX. 4 |
|---|---|---|---|---|---|
| INK COMPOSITION | CAB-O-JET (trade name) 260M *¹ | 50.0 (5.0) | 50.0 (5.0) | 50.0 (5.0) | 50.0 (5.0) |
| (% by weight) | glycerol | 35.0 | 35.0 | 35.0 | 35.0 |
| | dipropylene glycol | 5.0 | 5.0 | 5.0 | 5.0 |
| | dipropylene glycol-n-propyl ether | 2.0 | 2.0 | 2.0 | 2.0 |
| | SUNNOL (trade name) NL-1430 *² | 1.0 (0.28) | 1.0 (0.28) | 1.0 (0.28) | 1.0 (0.28) |
| | water | balance | balance | balance | balance |

| | | | | |
|---|---|---|---|---|
| Phosphate ion concentration (ppm) | 0.4 | 14.9 | 15.2 | 19.3 |
| Nickel elution amount (ppm) | 0.9 | 2.2 | 5.1 | 6.5 |
| Immersion Evaluation | G | G | G | G |

*¹ Self-dispersible magenta pigment dispersion, produced by Cabot Specialty Chemicals; C.I. Pigment Red 122 concentration:
10% by weight, number in parenthesis indicates pigment solid content amount
*² sodium polyoxyethylene alkyl (C = 12, 13) ether sulfate (3EO), produced by Lion Corporation, active content
amount: 28% by weight, number in parenthesis indicates active content amount

| | | COMP. | COMP. | COMP. | COMP. | COMP. |
|---|---|---|---|---|---|---|
| | | EX. 1 | EX. 2 | EX. 3 | EX. 4 | EX. 5 |
| INK COMPOSITION | CAB-O-JET (trade name) 260M *¹ | 50.0 (5.0) | 50.0 (5.0) | 50.0 (5.0) | 50.0 (5.0) | 50.0 (5.0) |
| (% by weight) | glycerol | 35.0 | 35.0 | 35.0 | 35.0 | 35.0 |
| | dipropylene glycol | 5.0 | 5.0 | 5.0 | 5.0 | 5.0 |
| | dipropylene glycol-n-propyl ether | 2.0 | 2.0 | 2.0 | 2.0 | 2.0 |
| | SUNNOL (trade name) NL-1430 *² | 1.0 (0.28) | 1.0 (0.28) | 1.0 (0.28) | 1.0 (0.28) | 1.0 (0.28) |
| | water | balance | balance | balance | balance | balance |

| | | | | | |
|---|---|---|---|---|---|
| Phosphate ion concentration (ppm) | 21.7 | 24.8 | 32.6 | 50.4 | 103.6 |
| Nickel elution amount (ppm) | 56.9 | 59.0 | 56.0 | 54.7 | 49.7 |
| Immersion Evaluation | NG | NG | NG | NG | NG |

*¹ Self-dispersible magenta pigment dispersion, produced by Cabot Specialty Chemicals; C.I. Pigment Red 122 concentration:
10% by weight, number in parenthesis indicates pigment solid content amount
*² sodium polyoxyethylene alkyl (C = 12, 13) ether sulfate (3EO), produced by Lion Corporation, active content
amount: 28% by weight, number in parenthesis indicates active content amount

| | | REF. | REF. | REF. | REF. |
|---|---|---|---|---|---|
| | | EX. 1 | EX. 2 | EX. 3 | EX. 4 |
| INK COMPOSITION | C.I. Pigment Red 122 | 5.0 | 5.0 | 5.0 | 5.0 |
| (% by weight) | glycerol | 30.0 | 30.0 | 30.0 | 25.0 |
| | dipropylene glycol | 5.0 | 5.0 | 5.0 | 5.0 |
| | dipropylene glycol-n-propyl ether | 2.0 | 2.0 | 2.0 | 2.0 |
| | SUNNOL (trade name) NL-1430 *¹ | 1.0 (0.28) | 1.0 (0.28) | 1.0 (0.28) | 1.0 (0.28) |
| | DISPERBYK(trade name)-190 *² | 3.0 | 3.0 | 3.0 | 3.0 |
| | water | balance | balance | balance | balance |

| | | | | |
|---|---|---|---|---|
| Phosphate ion concentration (ppm) | 0 | 20.9 | 52.3 | 104.6 |
| Nickel elution amount (ppm) | 0.6 | 1.9 | 1.7 | 1.7 |
| Immersion Evaluation | G | G | G | G |

*¹ sodium polyoxyethylene alkyl (C = 12, 13) ether sulfate (3EO), produced by Lion Corporation, active content
amount: 28% by weight, number in parenthesis indicates active content amount
*² Polymeric pigment dispersant, produced by BYK-Chemie GmbH

| | | REF. | REF. | REF. |
|---|---|---|---|---|
| | | EX. 5 | EX. 6 | EX. 7 |
| INK COMPOSITION | CAB-O-JET (trade name) 250C *¹ | 30.0 (3.0) | 30.0 (3.0) | 30.0 (3.0) |
| (% by weight) | glycerol | 40.0 | 40.0 | 40.0 |
| | dipropylene glycol | 5.0 | 5.0 | 5.0 |
| | dipropylene glycol-n-propyl ether | 2.0 | 2.0 | 2.0 |
| | SUNNOL (trade name) NL-1430 *² | 1.0 (0.28) | 1.0 (0.28) | 1.0 (0.28) |
| | water | balance | balance | balance |

| | | | |
|---|---|---|---|
| Phosphate ion concentration (ppm) | 15.7 | 20.9 | 44.8 |
| Nickel elution amount (ppm) | 3.4 | 2.5 | 2.6 |
| Immersion Evaluation | G | G | G |

*¹ Self-dispersible cyan pigment dispersion, produced by Cabot Specialty Chemicals; pigment concentration: 10% by weight, number
in parenthesis indicates pigment solid content amount
*² sodium polyoxyethylene alkyl (C = 12, 13) ether sulfate (3EO), produced by Lion Corporation, active content: 28% by
amount weight, number in parenthesis indicates active content amount

As shown in TABLE 1, in Examples 1-4 in which the phosphate ion concentration was not more than 20 ppm, the nickel elution amount was small that was not more than 6.5 ppm and the results of immersion evaluation were also satisfactory. In Example 1 in which the phosphate ion concentration was not more than 0.4 ppm, the nickel elution amount was further small that was not more than 1.0 ppm and the result of immersion evaluation was also satisfactory. On the other hand, in Comparative Examples 1-5 in which the phosphate ion concentration exceeded 20 ppm, the nickel elution amount was great that was about 50 ppm and the results of immersion evaluation were also inferior.

In Reference Examples 1-4 in which C.I. Pigment Red 122 was dispersed by using the polymeric pigment dispersant, as shown in TABLE 1, the nickel elution amount was small that was not more than 1.9 ppm regardless of the phosphate ion concentration, and the results of immersion evaluation were also satisfactory. However, Reference Examples 1-4 was inferior to Examples 1-4 in view of the controlling performance. Further, in Reference Examples 5-7 in which the self-dispersible cyan pigment of which surface was modified by the sulfonate group was used, the nickel elution amounts were small that was 2.5 ppm to 3.4 ppm regardless of the phosphate ion concentration, and the results of immersion evaluation were also satisfactory.

From the results of Reference Examples 1-7, it is found out that the phosphate ion concentration does not impart any effect on the metal corrosion in the ink which does not contain the self-dispersible magenta pigment. Therefore, it is found out that the effect of the present embodiments is characteristic for the water-based ink using C.I. Pigment Red 122 which is the self-dispersible magenta pigment and of which surface is modified by sulfonate acid.

What is claimed is:

1. A water-based ink for ink-jet recording comprising:
a self-dispersible C.I. Pigment Red 122 of which surface is modified by sulfonate group;
water; and
a water-soluble organic solvent,
wherein the water-based ink contains phosphate ion with not more than 20 ppm.

2. The water-based ink for ink-jet recording according to claim 1, wherein the water-based ink contains the phosphate ion with not more than 0.4 ppm.

3. The water-based ink for ink-jet recording according to claim 1, wherein the water-based ink for ink-jet recording is a magenta water-based ink.

4. An ink cartridge comprising the water-based ink for ink-jet recording as defined in claim 1.

5. The ink cartridge according to claim 4, wherein the water-based ink for ink-jet recording is a magenta water-based ink.

6. An ink-jet recording apparatus comprising:
an ink accommodating section accommodating the ink cartridge as defined in claim 4;
an ink-jet head which ejects the water-based ink accommodated in the ink accommodating section; and
a metal member which contacts with the water-based ink.

7. The ink-jet recording apparatus according to claim 6, wherein the metal member is a metal member of the ink-jet head.

8. The ink-jet recording apparatus according to claim 6, wherein the metal member contains nickel.

9. An ink-jet recording method including:
preparing the water-based ink for ink-jet recording as defined in claim 1; and
performing an ink-jet recording by ejecting the water-based ink onto an object.

10. A method for producing a water-based ink for ink-jet recording, the method including:
performing ultrafiltration for a self-dispersible C.I. Pigment Red 122 dispersion of which surface is modified by the sulfonate group; and
mixing the self-dispersible C.I. Pigment Red 122 dispersion for which the ultrafiltration is performed, water, and a water-soluble organic solvent;
wherein the water-based ink contains phosphate ion with not more than 20 ppm.

11. The method for producing the water-based ink for ink-jet recording according to claim 10, wherein the water-based ink contains the phosphate ion with not more than 0.4 ppm.

12. A method for preventing corrosion of a metal member, of an ink-jet recording apparatus, which contacts with a water-based ink for ink-jet recording, the method including:
preparing, as the water-based ink for ink-jet recording, a water-based ink which includes a self-dispersible C.I. Pigment Red 122 of which surface is modified by sulfonate group; water; and a water-soluble organic solvent, and
contacting the water-based ink with the metal member,
wherein the water-based ink contains phosphate ion with not more than 20 ppm.

13. The method for preventing corrosion of the metal member according to claim 12, wherein the water-based ink contains the phosphate ion with not more than 0.4 ppm.

14. The method for preventing corrosion of the metal member according to claim 12, wherein the preparing of the water-based ink for ink-jet recording includes: performing ultrafiltration for a dispersion of the self-dispersible C.I. Pigment Red 122; and mixing the dispersion for which the ultrafiltration is performed, the water, and the water-soluble organic solvent.

15. The method for preventing corrosion of the metal member according to claim 12, wherein the ink-jet recording apparatus includes an ink-jet head which ejects the water-based ink; and
the metal member is a metal member of the ink-jet head.

16. The method for preventing corrosion of the metal member according to claim 12, wherein the metal member contains nickel.
